(19) United States
(12) Patent Application Publication
(10) Pub. No.: US 2015/0100621 A1
(43) Pub. Date: Apr. 9, 2015

(54) User Interface for a System Including Smart Phone and Smart Watch

(71) Applicant: Yang Pan, Singapore (SG)

(72) Inventor: Yang Pan, Singapore (SG)

(21) Appl. No.: 14/045,779

(22) Filed: Oct. 3, 2013

(51) Int. Cl. H04L 29/08; H04L 29/06; H04W 4/00

(52) U.S. Cl. CPC H04L 67/10; H04W 4/008; H04L 67/42
USPC 709/203

(57) ABSTRACT

System and method for operating a smart phone and a smart watch connectable through an ad hoc communication link is provided. Operations of the smart watch can be controlled by employing a virtual watch user interface operated through the smart phone. The user interface is displayed in a synchronized manner between the phone and the watch. The user can switch freely between the phone and the watch employing the same user interfaces. In another aspect, the smart phone can be operated in a low power mode mimicking the operations of the smart watch.

### CROSS-REFERENCE TO RELATED APPLICATIONS

Not applicable.

### BACKGROUND

1. Field oOf Invention

This disclosure relates generally to user interface. More specifically, the disclosure relates to methods for operating a system comprising a handheld device and a wearable device.

2. Description of Prior Art

Handheld computing and communication devices have gained significant popularity in recent years. Users are using the handheld devices such as, for example, iPhone, iPod and iPad from Apple Inc, Cupertino, Calif., to enjoy media assets and to access the Internet services. Methods for a user interfacing with the devices have been developed. Graphical User Interface (GUI) based on touch-sensitive display has been adopted widely in recent years.

Wearable devices have recently attracted significant attentions. Wearable devices include smart watches, smart glasses and smart garments. The wearable devices with smaller display sizes are difficult to operate. Value propositions for the wearable devices have not become clear despite of strong initiatives from several major players in the mobile communication industry.

### SUMMARY OF THE INVENTION

It is an object of the present invention to providing a system and method for operating a wearable device through leveraging a connected handheld device to ease difficulties associated with operating the device with a small display.

It is another object of the present invention to providing a method for a user to switch freely between a wearable device and a handheld device by displaying every hierarchical level of the user interface on a phone display and on a watch display in a synchronized manner and therefore to ease difficulties associated with operating the device with a smaller display.

It is yet another object of the present invention to providing a system and method that enables the handheld device to be operated in a low-power mode by mimicking operations of the wearable device.

In an exemplary case, the handheld device is a smart phone and the wearable device is a smart watch. The phone and the watch can be connected through an ad hoc communication link such as, for example, through a Bluetooth type of connection.

The phone includes a default user interface for the phone and the watch includes a default user interface for the watch. The UI for the watch is typically simpler than the one for the phone because of smaller display size and less processing power. The phone includes a virtual UI for the watch. An icon for the virtual UI can be displayed on the smart phone as a user selectable item.

In one embodiment, the user selects the icon for the virtual UI through the phone user interface. In response to user selection, the first screen of the virtual UI is displayed on the phone. The user navigates through the UI and selects an application. In response to the user's selection, a processor of the phone transmits a data file including data related to selected application to the watch through the ad hoc communication link. A processor of the watch executes the application accordingly.

In another embodiment, a control signal is transmitted from the processor of the phone to the processor of the watch in response to the user's selection of the icon for the virtual UI. Every hierarchical level of the UI is displayed in a synchronized manner on the display for the phone and on the one for watch. The user inputs can be received either from the phone or from the watch through the user's interactions with one of the devices. The user can switch freely between two devices by navigating through either one of the synchronized user interfaces. An application can be selected by the user employing either one of the devices. The processor of the watch executes selected application accordingly.

In yet another embodiment, the phone includes a low-power processor or a low-power operating mode of the processor. The phone further includes a virtual storage unit for storing data in the watch. The phone can be operated in a low-power operating mode employing the virtual UI of the watch. The phone is operated in a way mimicking operations of the watch.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an exemplary system comprising a mobile server and a mobile client connectable through an ad hoc communication link;

FIG. 2A is a schematic diagram of an exemplary system comprising a smart phone and a smart watch connectable through an ad hoc communication link;

FIG. 2B is a schematic diagram of exemplary functional blocks for the smart phone and the smart watch;

FIGS. 3A-D is a schematic diagram illustrating operation of the system in accordance with a first embodiment;

FIGS. 4A-B is a schematic diagram illustrating operation of the system in accordance with a second embodiment;

FIG. 5 is a flowchart illustrating an exemplary operation of the system in accordance with the first embodiment;

FIG. 6 is a flowchart illustrating an exemplary operation of the system in accordance with one aspect of the second embodiment;

FIG. 7 is a flowchart illustrating an exemplary operation of the system in accordance with another aspect of second embodiment;

FIG. 8 is a schematic diagram of exemplary functional blocks for the smart phone and the smart watch in accordance with a third embodiment;

FIG. 9 is a flowchart illustrating an exemplary operation of the system in accordance with the third embodiment.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

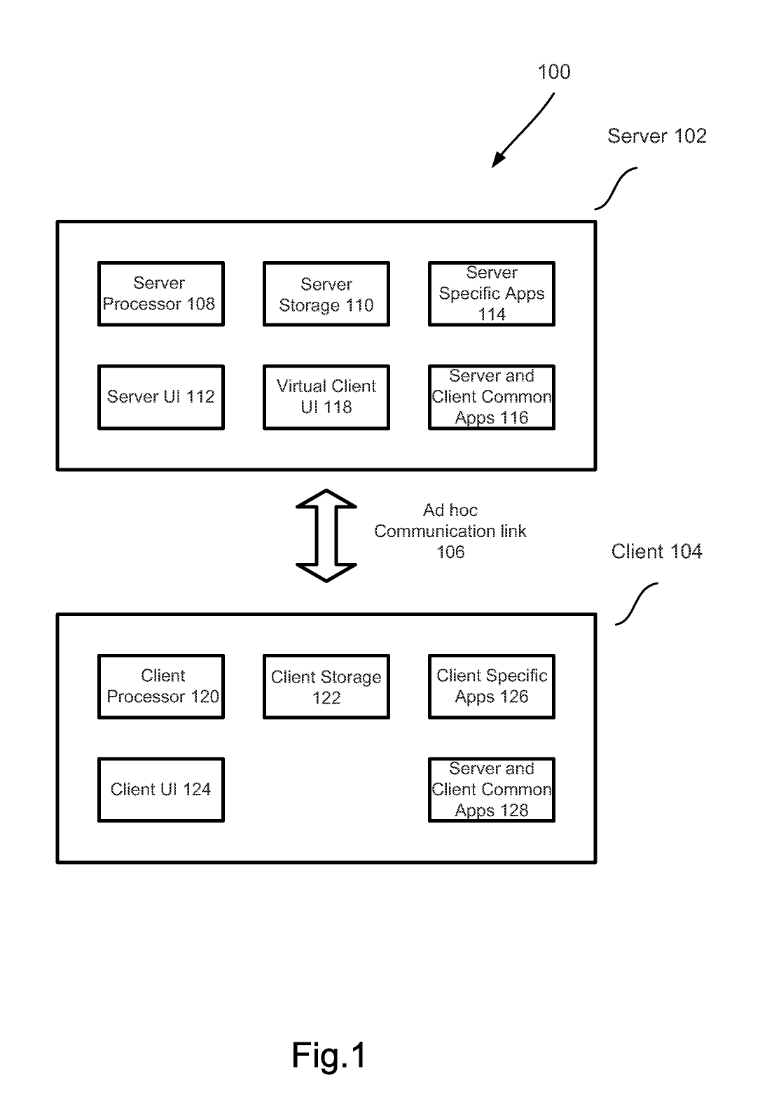

FIG. 1 is a schematic diagram of an exemplary system 100. System 100 includes a server 102 and a client 104. Server 102 and client 104 are connectable through an ad hoc communication link 106. Server 102 further includes server processor 108. Server processor 108 may include a low-power operating mode. Server processor 108 may further include a plurality of processors including a low power processor. Server 102 further includes a server storage unit 110 and server User Interface (UI) 112. Server 102 includes two types of applications: server specific applications 114 and server and client common applications 116. Server specific applications 114 are the applications that can only be run in server 102. For example, server 102 can be connected to the Internet through a network interface (not shown in the figure). Client 104 can only be connected to server 102 through ad hoc communication link 106. Client 104 cannot be connected to the Internet directly. Server and client common applications 116 are applications that can be run in server 102 and also in client 104. For example, a media item can be rendered through either one of the devices. Server 102 further includes a virtual client UI 118 pertaining to running a client UI in server 102.

Client 104 includes client processor 120 and client storage unit 122. Client processor 120 is typically less powerful than server processor 108. Client processor 120 consumes substantially less power than server processor 108. Client 104 is operated utilizing of client UI 124. Client 104 can execute applications 126 that are specific to client 104. For example, client 104 may include sensors (not shown in the figure) unique to client 104 such as, for example, a pedometer. Client 104 also includes applications 128 that are common to server 102.

An application executed by server 102 through UI 112 may consume more power than the same application executed by client 104 through UI 124.

In one aspect, server 102 can control operations of client 104 by running virtual client UI 118 in server 102. The user selects an application in a progressive manner through virtual client UI 118. A control signal is transmitted from server 102 to client 104 through ad hoc communication link 106. In response to the control signal, client 104 executes selected application. In one implementation, every hierarchical level of the user interface of client 104 can be displayed on both server 102 and client 104 in a synchronized manner. The user can switch freely between two devices by navigating through either one of the synchronized user interfaces to select the application.

In another aspect, server and client common applications 116 can be run in server 102 through virtual client UI 118. Server 102 run by processor 108 is operated under a low-power mode mimicking operations of client 104. The feature is very useful when server 102 is running out of power while the user wants to continue to use the device for limited functionalities.

In an exemplary case, server 102 and client 104 are mobile computing and communication devices. In one implementation, server 102 is a smart phone and client 104 is a smart watch. In another implementation, server 102 is a tablet computer and client device 104 is a smart watch. In yet another implementation, server 102 is a laptop computer and client device 104 is a smart watch. In still other implementations, clients 104 are smart glasses. In still other implementations, server 102 is tablet computer or a laptop computer while client 104 is a smart phone.

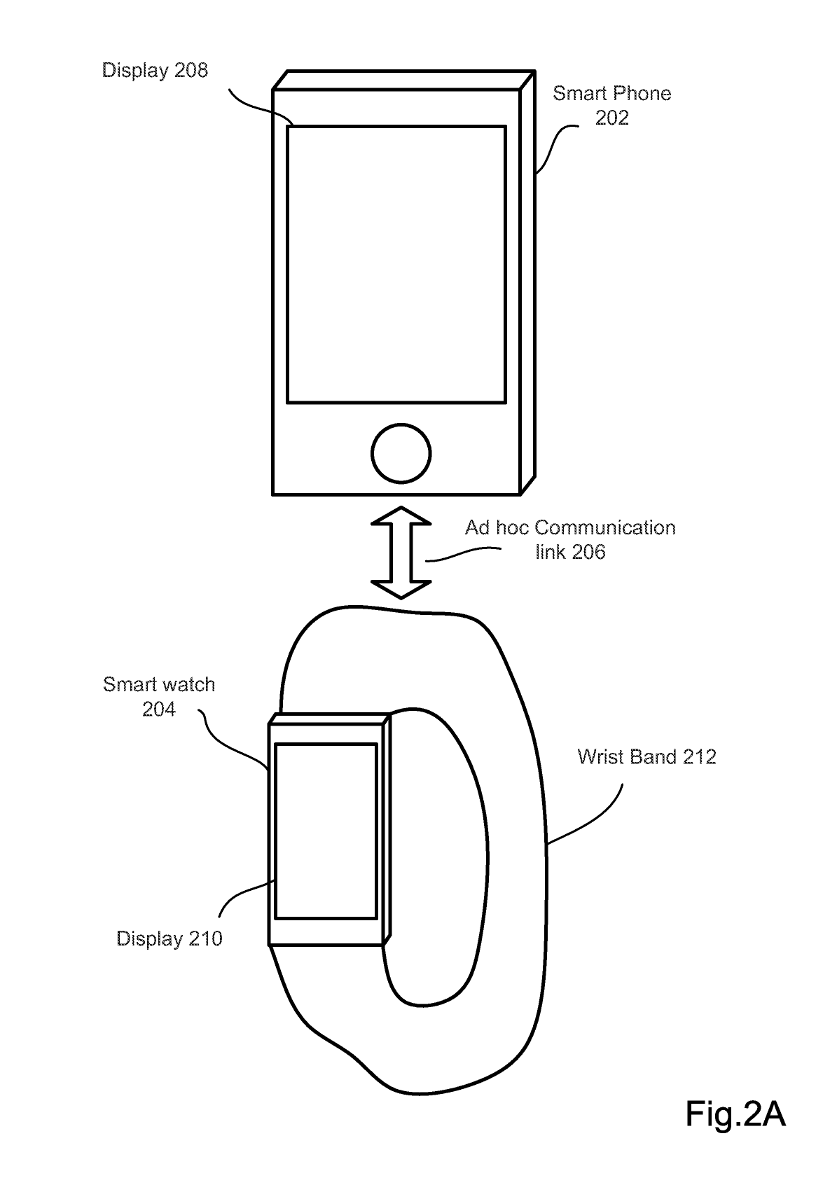

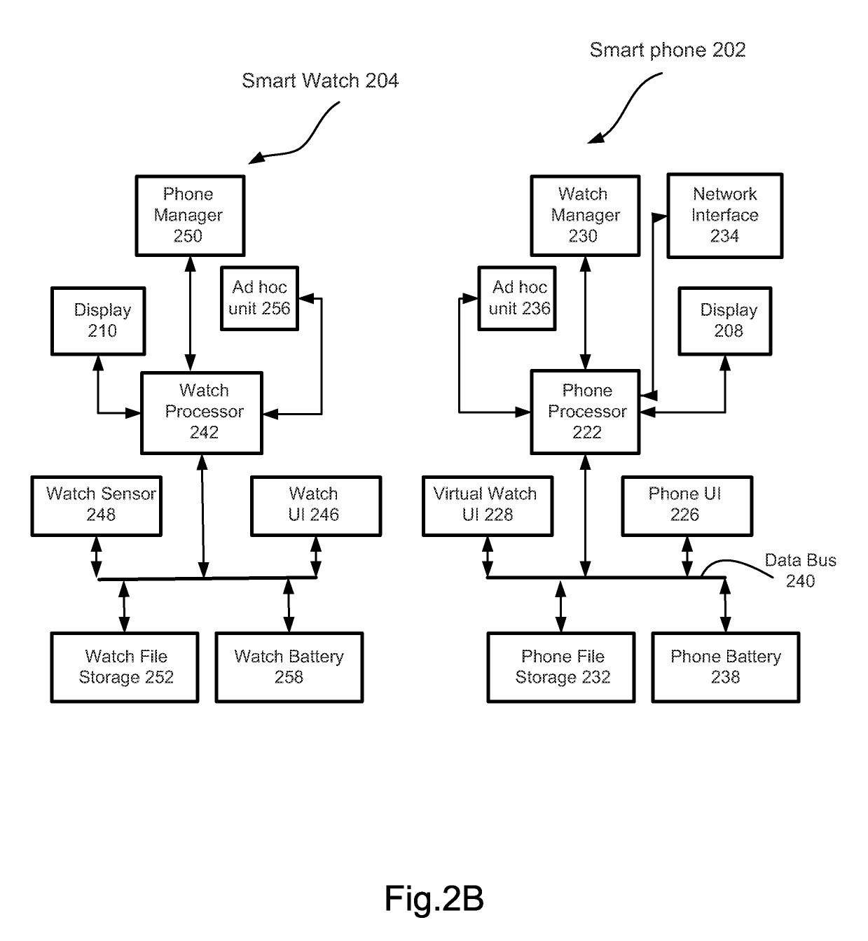

A smart phone as server 102 and a smart watch as client 104 are used exemplarily in the present disclosure to illustrate the inventive concept, which should not limit scope of the inventive concept. As depicted in FIG. 2, smart phone 202 and smart watch 204 are connected through ad hoc communication link 206. Smart phone 202 further includes a display 208. Smart watch 204 further includes a display 210 and a wrist band 212. In an exemplary case, both of the displays are touch-sensitive type of displays. Ad hoc communication link 206 includes but is not limited to a Bluetooth type of connection, a ZigBee type of connection and a Near Field Communication (NFC) type of connection.

In an exemplary implementation, a reader is disposed in smart phone 202 and a storage tag is disposed in smart watch 204. The reader can read from and write to the tag. In another exemplary case, smart phone 202 includes a first set of reader and tag and smart watch 204 includes a second set of reader and tag. The reader in smart phone 202 reads and writes to the tag in smart watch 204. The reader in smart watch 204 reads from and writes to the tag in smart phone 202.

Smart phone 202 and smart watch 204 are connected when the two devices are within a predetermined distance. An authenticity check is typically conducted before the connection is confirmed.

FIG. 2B is a schematic diagram of exemplary functional blocks for smart phone 202 and for smart watch 204. Smart phone 202 comprises phone processor 222 and phone display 208. Display 208 is a touch-sensitive display in an exemplary case. Smart phone 202 further includes phone UI 226 and virtual watch UI 228. An exemplary user interface includes multiple hierarchical levels. A plurality of user selectable icons is displayed on the touch-sensitive display at one of the hierarchical levels. Some of UI may include only two hierarchical levels. Some may include more than two hierarchical levels. A user interface for selecting a media item includes more than two hierarchical levels. Virtual watch UI 228 is a user interface mimicking operations of smart watch 204 in smart phone 202. UI 228 takes typically simpler form than UI 226 because of smaller display size in smart watch 204.

Smart phone 202 further includes phone file storage 232 including a plurality of flash memory modules and Random Access Memory (RAM) modules. Smart phone 202 includes network interface 234 pertaining to communicating with a communication network including but is not limited to the Internet and a public phone network. Smart phone 202 and smart watch 204 are connectable through ad hoc communication link 206. The ad hoc communication link 206 includes ad hoc communication unit 236 in smart phone 202 and unit 256 in smart watch 204. In one implementation unit 236 and unit 256 conform to the Bluetooth standards and their extensions. In another implementation, the units conform to the ZigBee standards and their extensions. In yet another implementation, the units conform to the NFC standards and their extensions. Smart phone 202 further includes watch manager 230 pertaining to managing its interactions with smart watch 204. Watch manager 230 is a piece of software stored in phone file storage 232 and is executable by phone processor 222. Operations of smart phone 202 are powered by phone battery 238. Phone battery 238 may be a rechargeable battery. Phone battery 238 further includes power management unit (not shown in the figure). The power management unit monitors remaining power of battery 238 and may trigger smart phone 202 to be operated at a low-power mode. Functional blocks of smart phone 202 are connected through data bus 240.

Smart watch 204 includes watch processor 242 and watch display 210. Watch display 210 may have substantially smaller size than phone display 208. Smart watch 204 further comprises watch UI 246, which may take a simplified form of phone UI 226. Watch sensor 248 may provide watch specific applications such as, for example, applications related heath monitoring of the user. An example includes a pedometer in smart watch 204. Smart watch 204 also includes watch file storage 252. Watch file storage 252 may include a plurality of flash memory modules and RAM modules. Smart watch 204 further includes phone manager 250 pertaining to managing its interactions with smart phone 202. Phone manager 250 is a piece of software stored in watch storage 252 and is executable by watch processor 242. Operations of smart watch 204 are powered by watch battery 258. A power management unit may be included to manage power consumption of smart watch 204 (not shown in the figure).

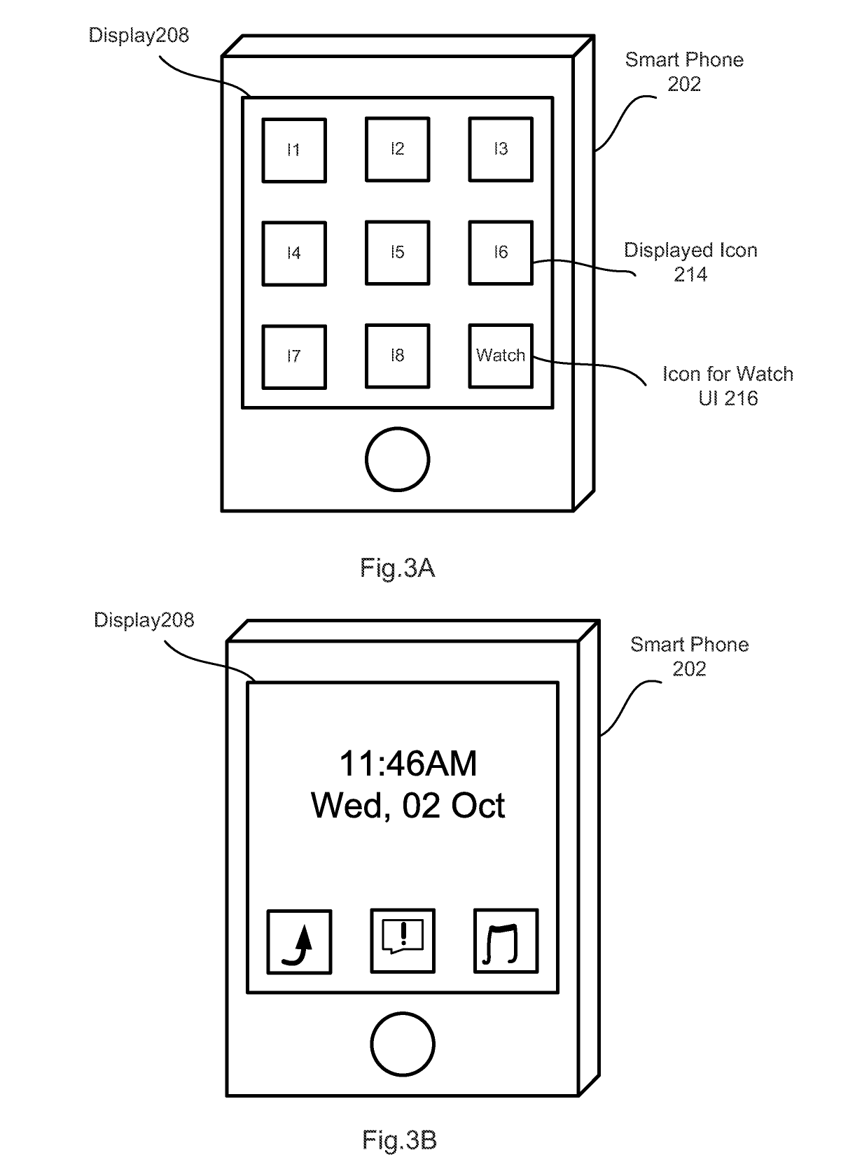

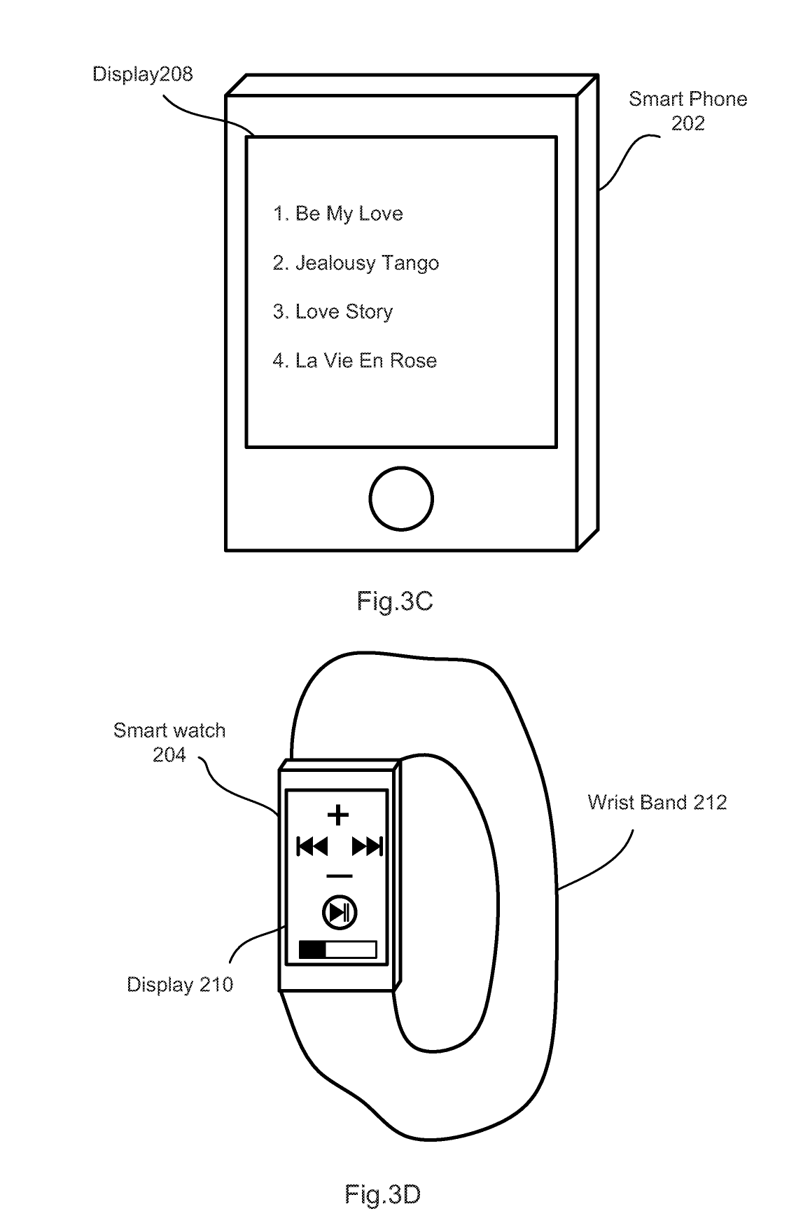

FIGS. 3A-D is a schematic diagram illustrating operation of the system in accordance with a first embodiment. As shown in FIG. 3A, a plurality of icons 214 is displayed on phone display 208. Icons 214 are representations of various applications for smart phone 202. The applications include but are not limited to phone, email, Internet browser, messages, calendar, maps, weather and accessing photos. An icon 216 for accessing virtual watch UI 228 is also displayed. The user can select icon 216 to have UI 228 rendered by employing of phone display 208. In response to the user selection, a first level of UI 228 is displayed on a refreshed screen as shown in FIG. 3B. A typical watch UI includes a display for current date and time and icons for a few applications. FIG. 3B is exemplary. Different icons and different arrangement for the icons can be implemented. In response to user exemplary selection of the icon for music, a plurality of user selectable media items are displayed on phone display 208. The user may be required to navigate through more than one hierarchical level to reach the user selectable media items. After the user selects one of the displayed media items, a data file is generated by phone processor 222 and is transmitted to smart watch 204. The data file includes data related to selected application. In the exemplary case as currently being illustrated, metadata of selected media item is transmitted to smart watch 204 from smart phone 202.

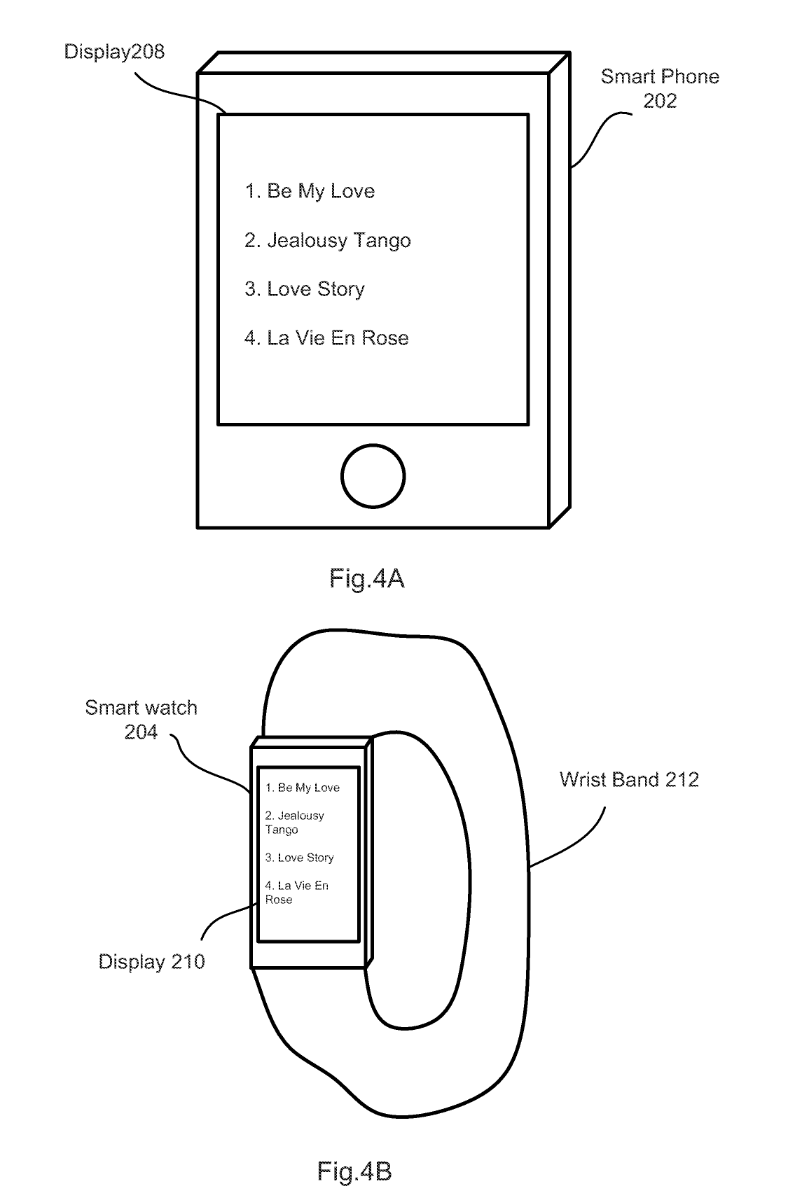

In response to received data file, watch processor 242 executes selected application employing smart watch 204. As shown in FIG. 4D, a control screen is displayed on watch display 210 while selected media item is being rendered.

FIGS. 4A-B is a schematic diagram illustrating operation of the system in accordance with a second embodiment. The user selects the icon representing virtual watch UI 228. In response to user selection, a data file including a control signal is transmitted from smart phone 202 to smart watch 204 through ad hoc communication link 206. Upon receiving the data file, watch processor 242 and phone processor 222 displays every hierarchical level of the user interface in a synchronized manner. In one implementation, smart phone 202 and smart watch 204 include a pair of calibrated clocks. The screens representing each of the hierarchical levels can therefore be displayed in a synchronized manner An exemplary illustration of displaying the same screens on smart phone 202 and on smart watch 204 is shown in FIGS. 4A-B. In one aspect, the user can switch from smart phone 202 to smart watch 204 at any time to complete an operation of selecting and executing an application. In another aspect, the user can switch freely between smart phone 202 and smart watch 204 at any time to complete the operation. Control signals can also be transmitted from smart watch 204 to smart phone 202 in order to synchronize operations of two devices.

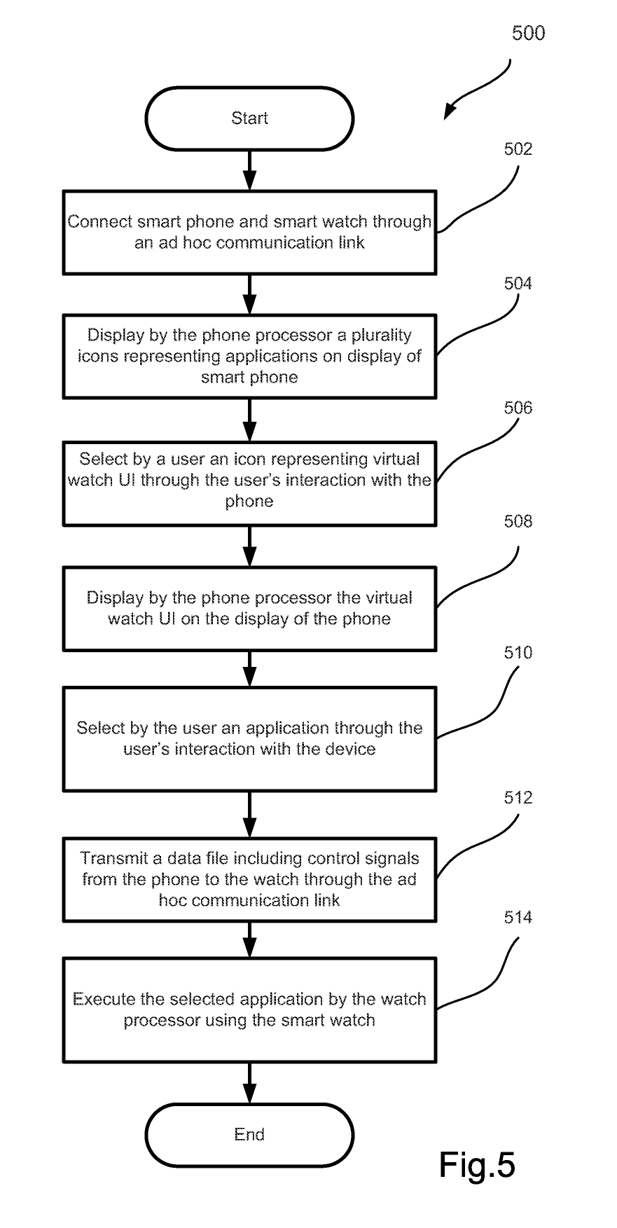

FIG. 5 is a flowchart illustrating an exemplary operation of the system in accordance with the first embodiment. Process 500 starts with step 502 that smart phone 202 and smart watch 204 are connected through ad hoc communication link 206. In one implementation, authenticities of the devices are checked before the link is confirmed. Ad hoc communication link may be a Bluetooth type of connection. The link may also be a NFC type of connection. A plurality of icons 214 representing various applications is displayed on phone display 208 in step 504. Displayed icons 214 include an icon 216 representing virtual watch UI 228. Icon 216 is selected by the user through the user's interaction with smart phone 202 in step 506. The first screen of UI 228 is displayed in response to the user selection of icon 216 in step 508. The user selects an application by navigating through virtual watch UI 228 in step 510. In response to the user's selection of the application, a data file including data related to selected application is transmitted from smart phone 202 to smart watch 204 in step 512. Upon receiving the data file, watch processor 242 executes the application employing smart watch 204 in step 514.

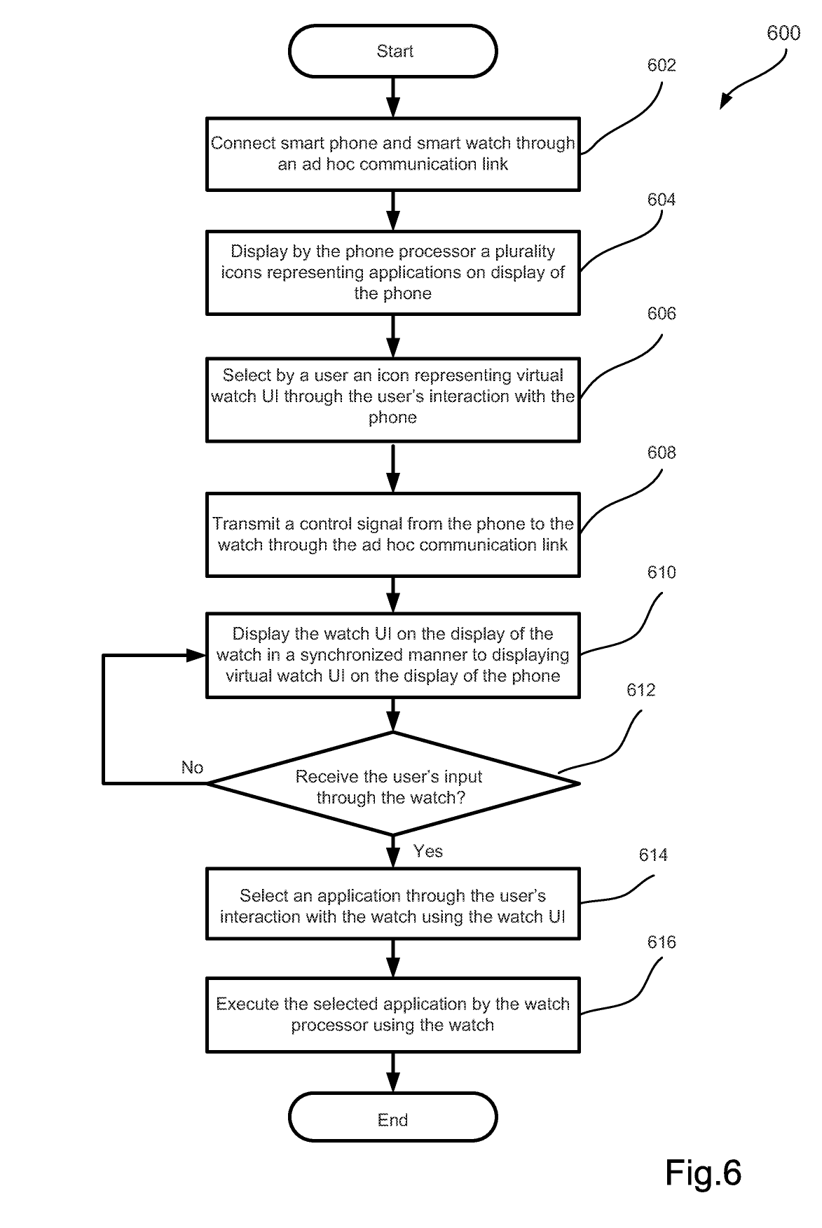

FIG. 6 is a flowchart illustrating an exemplary operation of the system in accordance with one aspect of the second embodiment. Process 600 starts with step 602 that smart phone 202 and smart watch 204 are connected through ad hoc communication link 206. A plurality of icons 214 representing various applications is displayed on phone display 208 in step 604. Displayed icons 214 include an icon 216 representing virtual watch UI 228. Icon 216 is selected by the user through the user's interaction with smart phone 202 in step 606. In response to the user's selection, a control signal is transmitted from smart phone 202 to smart watch 204 in step 608. Screens in the same hierarchical level of UI 228 and UI 246 are displayed in a synchronized manner in step 610. Watch processor 242 checks in step 612 if the user's input through UI 246 is received as a result of the user's interaction with smart watch 204. If the result is positive, an application is selected in step 614 by the user employing watch UI 246. In step 616, watch processor 242 executes selected application using smart watch 204.

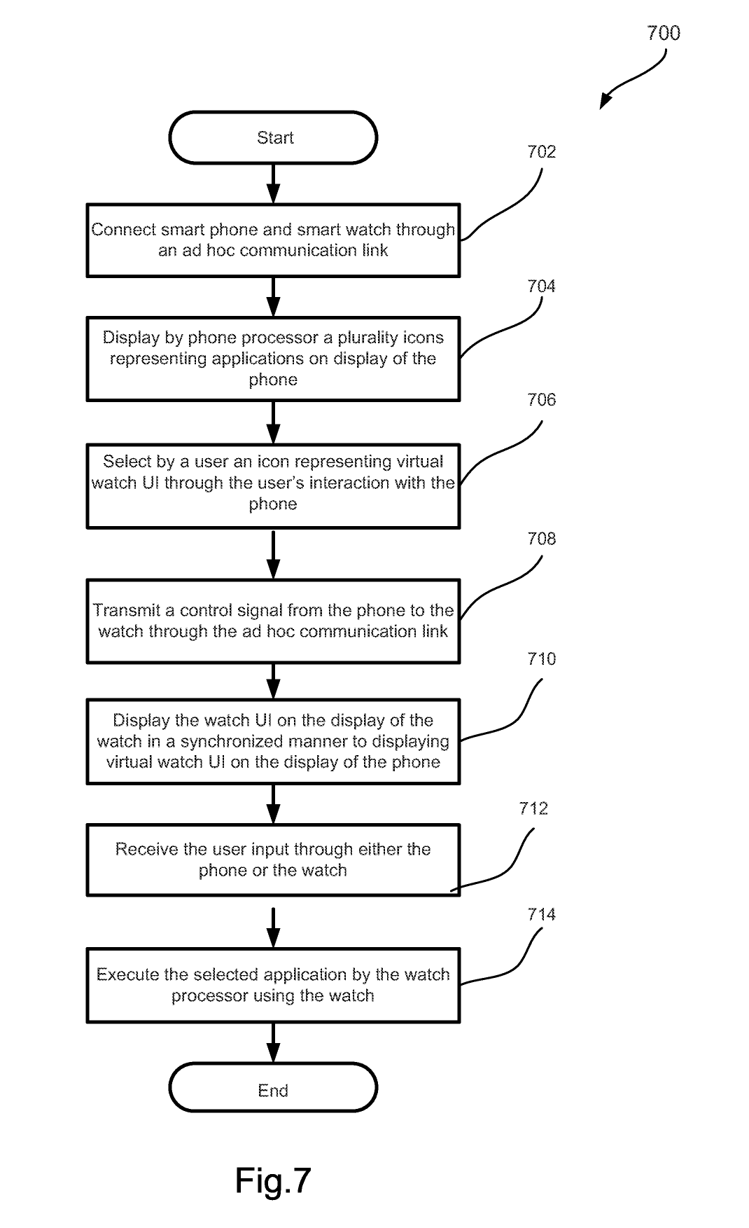

FIG. 7 is a flowchart illustrating an exemplary operation of the system in accordance with another the second embodiment. Process 700 starts with step 702 that smart phone 202 and smart watch 204 are connected through ad hoc communication link 206. A plurality of icons 214 representing various applications is displayed on phone display 208 in step 704. Displayed icons 214 include an icon 216 representing virtual watch UI 228. Icon 216 is selected by the user through the user's interaction with smart phone 202 in step 706. In response to the user's selection, a control signal is transmitted from smart phone 202 to smart watch 204 in step 708. Screens in the same hierarchical level of UI 228 and UI 246 are displayed in a synchronized manner in step 710. A user input can be received from either smart phone 202 or from smart watch 204 in step 712. An application is selected from either smart phone 202 or smart watch 204. In response to selected application, watch processor 242 executes selected application using smart watch 204 in step 714.

In another implementation (not included in FIG. 7), selected application can also be executed by phone processor 222 employing smart phone 202. The present invention provides flexibilities for the user to switch between two devices freely at any hierarchical level of the user interface and to select anyone of the devices for executing the application.

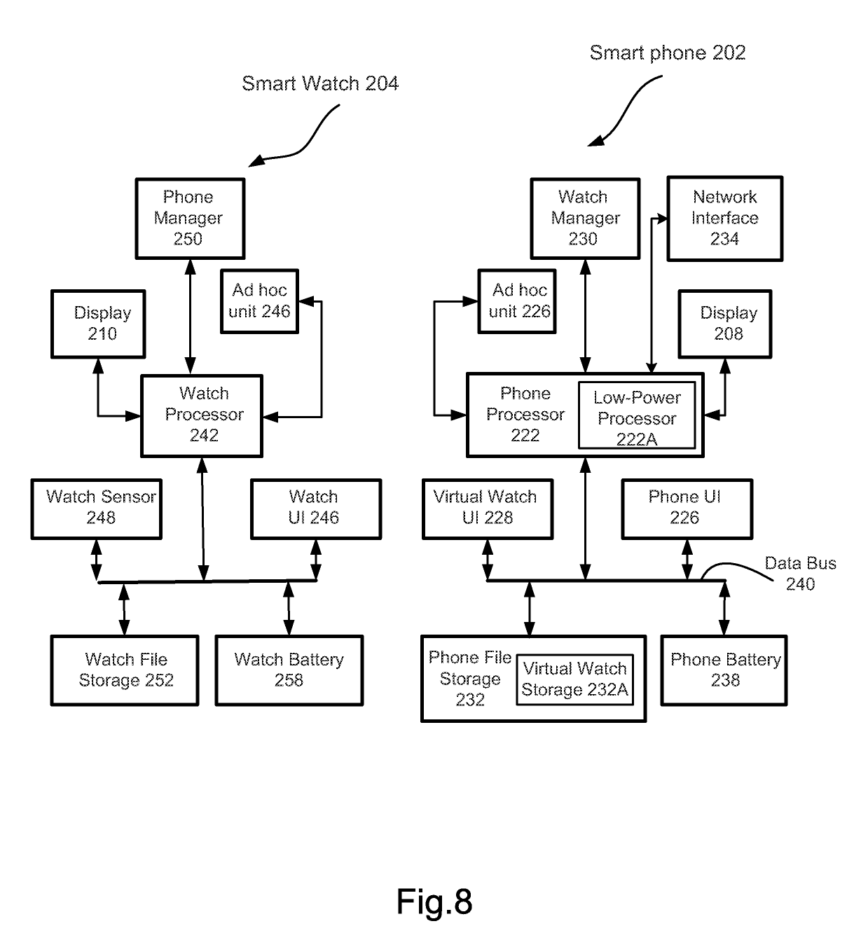

FIG. 8 is a schematic diagram of exemplary functional blocks for smart phone 202 and for smart watch 204 in accordance with a third embodiment. In one implementation, phone processor 222 includes a low-power processor 222A. Processor 222A consumes substantially less power than processor 222 in full functions. Processor 222A can be operated independently as a standalone processor pertaining to controlling operations of smart phone 202 in a low power mode. In another implementation, low power processor 222A is a low-power operating mode of processor 222.

Smart phone 202 further includes a virtual watch storage unit 232A. Data stored in phone storage 232 and in watch storage 252 are organized into various databases. Some of the databases in smart watch 204 are synchronized to the databases in smart phone 202. Some databases are specific to smart phone 202. Some databases are specific to smart watch 204. Virtual storage 232A stores metadata of data files belonging to databases that have been synchronized. In one implementation, virtual storage 232A stores metadata of data specific to smart watch 204. In another implementation, virtual storage 232A stores actual data for the data specific to smart watch 204. In cases that metadata are stored in virtual watch storage 232A, data files represented by the metadata are retrieved from either phone storage 232 or from watch storage 252 through ad communication link.

In yet another implementation, virtual watch storage 232A stores all actual data files of smart watch 204. Stored data files are duplications of the data files already stored in watch storage 252,

Smart phone 202 is operated under a low-power mode by running virtual watch UI 228. Low power processor 222A controls operations of smart phone 202. Processor 222A retrieves data files directly or indirectly from virtual watch storage 232A. Smart phone 202 mimics operations of smart watch 204 to save power consumption according to the third embodiment.

Smart phone 202 may utilize a full size phone display 208 in one implementation. Smart phone 202 may utilize only a part of phone display 208 in another implementation to save power consumption.

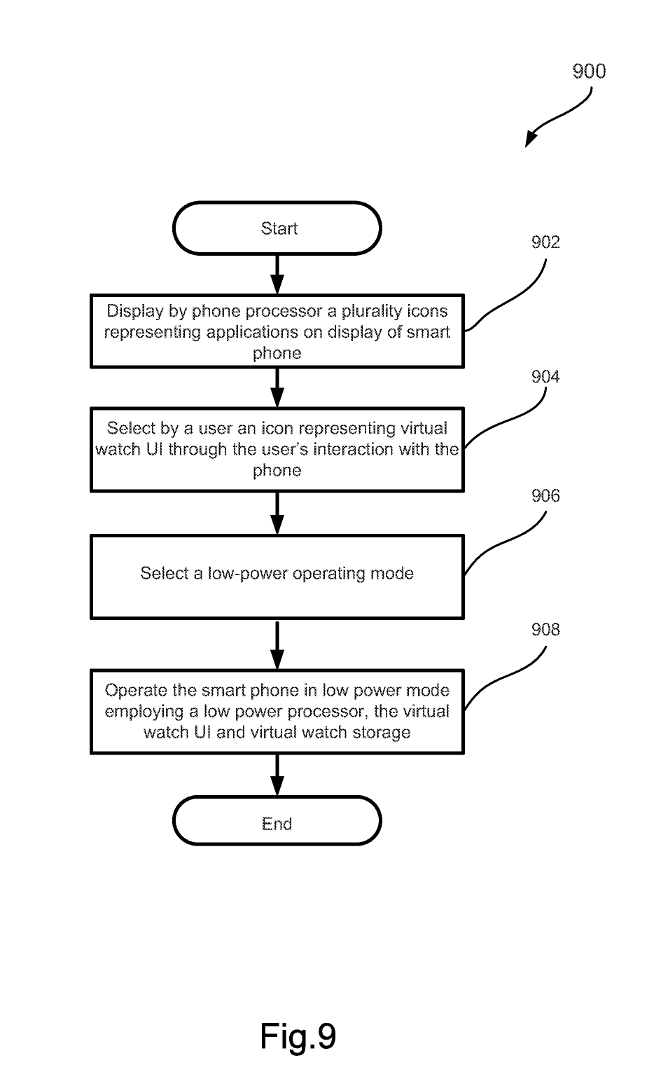

FIG. 9 is a flowchart illustrating an exemplary operation of the system in accordance with the third embodiment. Process 900 starts with step 902 that a plurality of icons 214 is displayed on phone display 208 by phone processor 222. One of the icons 216 represents virtual watch UI 228. The user selects icon 216 in step 904 through the user's interaction with smart phone 202. A low-power operating mode is selected in step 906 either by the user or by processor 222. In one implementation, processor 222 switches smart phone 202 to the low-power operating mode if measured remaining power of phone battery 238 is below a threshold value. The user may also select the low-power operating mode proactively. In response to the user selection, smart phone 202 is operated in step 908 by low power processor 222A. In the low-power operating mode, virtual watch UI 228 and virtual watch storage 232A are used to save the power consumption. Smart phone 202 is operated in mimicking of the operations of smart watch 204.

1. A method of operating a system comprising a mobile server and a mobile client connected through an ad hoc communication link, comprising:
a. displaying by a processor of the server a plurality of items on a display of the server, wherein one of the items is a representation of a user interface for the client;
b. selecting by a user said one of the items through user's interacting with the server;
c. displaying said user interface for the client on the display of the server;
d. selecting an application by the user through said user interface displayed on the server;
e. transmitting a data file including data related to selected application from the server to the client through the ad hoc communication link; and
f. executing selected application by the processor of the client.

2. The method as recited in claim 1, wherein said user interface further includes at least two hierarchical levels.

3. The method as recited in claim 1, wherein said server further includes a smart phone.

4. The method as recited in claim 1, wherein said client further includes a smart watch.

5. The method as recited in claim 1, wherein said ad hoc communication link further includes a Bluetooth type of connection.

6. The method as recited in claim 1, wherein said ad hoc communication link further includes a Near Field Communication type of connection.

7. The method as recited in claim 6, wherein the client further includes a reader and a storage tag and the server further includes a reader and a storage tag.

8. The method as recited in claim 1, wherein said method further comprises a step of verifying identities of the server and the client.

9. A method of operating a system comprising a mobile server and a mobile client connected through an ad hoc communication link, comprising:
a. displaying by a processor of the server a plurality of items on a display of the server, wherein one of the items is a representation of a user interface for the client;
b. selecting by a user said one of the items through user interaction with the server;
c. transmitting a control signal from the server to the client through the ad hoc communication link;
d. displaying by the processor of the server and by a processor of the client every hierarchical level of the user interface in a synchronized manner on the display of the server and a display of the client;
e. receiving user inputs either through user's interacting with the server or through the user's interacting with the client;
f. selecting an application by the user through one of said synchronized user interfaces;
g. executing selected application by the processor of the client.

10. The method as recited in claim 9, wherein said user interface further includes at least two hierarchical levels.

11. The method as recited in claim 9, wherein the server further includes a smart phone.

12. The method as recited in claim 9, wherein the client further includes a smart watch.

13. The method as recited in claim 9, wherein the ad hoc communication link further includes a Bluetooth type of connection.

14. The method as recited in claim 9, wherein the ad hoc communication link further includes a Near Field Communication type of connection.

15. The method as recited in claim 14, wherein the client further includes a reader and a tag and the server further includes a reader and a tag.

16. A mobile system comprising:
a. a smart phone operated by a user employing a user interface displayed on a display of the phone;
b. a smart watch operated by the user employing a user interface displayed on a display of the watch, said phone and watch are connected through an ad hoc communication link; and
c. a means for operating smart phone by employing said user interface of the smart watch.

17. The system as recited in claim 16, wherein said smart phone further comprises a processor, wherein said processor further comprise a low-power processor or a low-power operating mode.

18. The system as recited in claim 16, wherein said smart phone further comprises a virtual user interface for said smart watch, wherein said virtual user interface is a software program stored in a storage unit of the smart phone.

19. The system as recited in claim 16, wherein said smart phone further comprises a virtual storage unit representing stored items in said smart watch.

20. The system as recited in claim 19, wherein said virtual storage unit comprises only metadata for at least a portion of stored items.
